(19) United States
(12) Patent Application Publication
(10) Pub. No.: US 2025/0119992 A1
(43) Pub. Date: Apr. 10, 2025

(54) TWIN COIL ARC SWEEP SYSTEM FOR VACUUM ARC REMELTING FURNACES

(71) Applicant: Titanium Metals Corporation, Henderson, NV (US)

(72) Inventors: Ashish D. PATEL, Wyomissing, PA (US); Nir HERSCOVICI, Las Vegas, NV (US); Jann Wyatt MESSER, Lancaster, PA (US); Daniel Francis FIORE, Sinking Spring, PA (US); Isaiah Shornell HENRY, Henderson, NV (US)

(73) Assignee: Titanium Metals Corporation, Henderson, NV (US)

(21) Appl. No.: 18/481,112

(22) Filed: Oct. 4, 2023

(51) Int. Cl. H05B 7/152; F27B 14/04; F27D 19/00; H01F 27/24; H01F 27/28; H05B 7/20

(52) U.S. Cl. CPC H05B 7/152; F27B 14/04; F27D 19/00; H05B 7/20; F27B 2014/045; F27D 2019/0037; H01F 27/24; H01F 27/28

(57) ABSTRACT

A vacuum arc remelting (VAR) system for forming an ingot from an electrode is disclosed. The system includes a crucible assembly configured to accommodate the electrode and the ingot. The system includes a primary electromagnetic energy source arranged about the crucible assembly. The primary electromagnetic energy source and the crucible assembly are configured to move relative to one another along a longitudinal axis of the crucible assembly. The system includes a secondary electromagnetic energy source arranged about an upper end portion of the crucible assembly. The secondary electromagnetic energy source is stationary and fixed to the upper end portion of the crucible assembly.

### FIELD

The present disclosure relates to vacuum arc furnaces, and more particularly to systems and methods for improving ingot surface quality from a vacuum arc remelting (VAR) furnace.

### BACKGROUND

The statements in this section merely provide background information related to the present disclosure and may not constitute prior art.

A vacuum arc remelting (VAR) process is generally used in the processing of high-performance titanium, zirconium, nickel based alloys and steel, among other alloys. Generally, a VAR system gradually melts an electrode by an electric current that flows through the electrode and arcs to molten metal contained within a crucible. The applied melting current is varied during the process, to achieve the desired molten metal pool geometry. At times, the electric arc can cause beads of metal to spatter onto portions of the crucible wall that are above the molten metal. These portions are cold and can solidify the beads into a porous nonhomogeneous mass, which can cause surface irregularities in the ingot.

These issues related to VAR ingot surface quality and internal quality, among other issues related to VAR processes, are addressed by the present disclosure.

### SUMMARY

This section provides a general summary of the disclosure and is not a comprehensive disclosure of its full scope or all of its features.

An electrode is generally remelted in a vacuum arc remelting (VAR) furnace where an arc is formed between an electrode and an ingot. As the electrode is remelted, the arc between the electrode and the ingot may be non-uniformly distributed along the electrode cross-section. For example, the portion of the electrode being melted by the arc may become concave or more distant from the ingot at the center of the electrode than the perimeter of the electrode. As discussed herein, an electromagnetic field may be used to direct the arc and enhance the properties in the resulting ingot. For example, the electromagnetic field causes the portion of the electrode being melted by the arc to become more convex or more distant from the ingot at the perimeter of the ingot than the center from the ingot. That is, the heat from the arc is directed outward from the center of the electrode, and the heat is continually being directed to the edges of the electrode to improve surface quality of the resulting ingot.

Generally, the VAR system of the present disclosure includes an electromagnetic energy source and a lift mechanism for moving the electromagnetic energy source with the growing molten metal (i.e., ingot), such that the magnetic field is localized. In one form, the electromagnetic energy source is a compact coil assembly, as described further herein. In one form, the coil assembly includes a ring-shaped magnetic core (e.g., toroidal), made up of a high permeability material and wound with insulated wires. The coil assembly is operable to generate a rotating magnetic field that is perpendicular to the normal axis of the coil assembly. The rotating magnetic field generated interacts with the melting current to move the arc radially in a direction perpendicular to the normal axis of the electrode and ingot. The arc behavior melts the beads on the ingot surface and thus improves the resulting ingot from the remelting process by continuously melting and maintaining the beads in the molten metal before solidifying in the ingot instead of the beads solidifying on the crucible. As the ingot grows, it solidifies on the crucible as opposed to a shell of splatter, beads, or otherwise.

Although the lift mechanism is illustrated and described herein as moving the electromagnetic energy source relative to the ingot, it should also be understood that the ingot may be moved relative to the electromagnetic energy source, or both the electromagnetic energy source and the ingot may move while remaining within the scope of the present disclosure.

Proper application of the electromagnetic field to the electrode during remelt may be challenged by impediments (e.g., structural, mechanical, electrical). For example, the electromagnetic energy source may be unable to move along the entirety of the perimeter. A second electromagnetic energy source according to the present disclosure is thus used to ensure the proper electromagnetic field is available for more of the remelting process than may be available with only one electromagnetic energy source. However, the introduction of another electromagnetic energy source may cause fields generated by the first source and the second source to be in conflict. For example, out-of-phase currents used to generate electromagnetic fields may cause cancellation or strength reduction of those fields at or near the arc location, which may reduce its effectiveness of arc movement. The present disclosure addresses these challenges as set for in greater detail below.

A vacuum arc remelting (VAR) system for forming an ingot from an electrode includes a crucible assembly configured to accommodate the electrode and the ingot. The crucible assembly includes an upper end portion and a lower end portion. The system includes a primary electromagnetic energy source arranged about the crucible assembly. The primary electromagnetic energy source and the crucible assembly are configured to move relative to one another along a longitudinal axis of the crucible assembly. The system includes a secondary electromagnetic energy source arranged about the upper end portion of the crucible assembly. The secondary electromagnetic energy source is stationary and fixed to the upper end portion of the crucible assembly.

In one or more forms, the vacuum arc remelting (VAR) system includes one or more of the following implementations described in this section, which may be implemented individually or in any combination. The system includes a primary current controller configured to provide electric current to the primary electromagnetic energy source. The system includes a secondary current controller configured to provide electric current to the secondary electromagnetic energy source. The system includes a master controller configured to receive process inputs and to provide current settings to each of the primary current controller and the secondary current controller based on the process inputs. The master controller is configured to communicate with a main VAR furnace controller. The process inputs may include a position of the primary electromagnetic energy source and electric current being provided to each of the primary electromagnetic energy source and the secondary electromagnetic energy source. Magnetic fields generated by the primary electromagnetic energy source and the secondary electromagnetic energy source are localized to an arc region during remelting.

The master controller is configured to provide commands to the primary current controller to increase the electric current being provided to the primary electromagnetic energy source as the primary electromagnetic energy source reaches a predetermined height. The electric current being provided to the primary electromagnetic energy source is increased exponentially to a saturation level at the predetermined height. In one or more forms, the master controller is configured to provide commands to the secondary current controller to increase the electric current being provided to the secondary electromagnetic energy source after the electric current being provided to the primary electromagnetic energy source reaches the saturation level. The master controller is configured to provide commands to the primary current controller to switch off the electric current being provided to the primary electromagnetic energy source after the electric current being provided to the secondary electromagnetic energy source reaches a predetermined level. The electric current being provided to both the primary electromagnetic energy source and the secondary electromagnetic energy source are in phase. The system includes a position sensor configured to transmit the position of the primary electromagnetic energy source relative to the crucible assembly to the master controller. Each of the primary electromagnetic energy source and the secondary electromagnetic energy source include a coil assembly having a magnetic core and a plurality of coil pairs wrapped around the core. The coil assembly is operable to generate a magnetic field from the coil assembly based on electric current flowing in the plurality of coil pairs. In one or more forms, each of the coil assemblies includes three coil pairs. In one or more forms, a coil pair of the three coil pairs may include a first layer winding and a second layer winding, the first winding configured to receive first electric current from a first circuit of a controller and the second winding configured to receive electric current from a second circuit of the controller. Each of the magnetic cores form a respective toroid and a center of each respective toroid is coaxial with the longitudinal axis. The primary electromagnetic energy source moves along the longitudinal axis of the crucible assembly. The system includes upper and lower limit switches configured to limit travel of the primary electromagnetic energy source. The system includes a position sensor configured to limit travel of the of the primary electromagnetic energy source.

In another form of the present disclosure, a vacuum arc remelting (VAR) system for forming an ingot from an electrode includes a crucible assembly configured to accommodate the electrode and the ingot. The crucible assembly includes an upper end portion and a lower end portion. The system includes a primary electromagnetic energy source arranged about the crucible assembly. The primary electromagnetic energy source and the crucible assembly are configured to move relative to one another along a longitudinal axis of the crucible assembly. The system includes a secondary electromagnetic energy source arranged about the upper end portion of the crucible assembly. The secondary electromagnetic energy source is stationary and fixed to the upper end portion of the crucible assembly. The system includes a current controller configured to provide electric current to the primary electromagnetic energy source. In one or more forms, the current controller increases the electric current being provided to the primary electromagnetic energy source as the primary electromagnetic energy source reaches a predetermined height. The electric current being provided to the primary electromagnetic energy source is increased exponentially up to a saturation level associated with the predetermined height. In one or more forms, the system includes a master controller that is configured to provide commands to the current controller to increase the electric current being provided to the secondary electromagnetic energy source after the electric current being provided to the primary electromagnetic energy source reaches the saturation level.

Yet another vacuum arc remelting (VAR) system for forming an ingot from an electrode is provided by the present disclosure, which includes a crucible assembly configured to accommodate the electrode and the ingot. The crucible assembly includes an upper end portion and a lower end portion. The system includes a primary electromagnetic energy source arranged about the crucible assembly. The primary electromagnetic energy source and the crucible assembly are configured to move relative to one another along a longitudinal axis of the crucible assembly. The system includes a secondary electromagnetic energy source arranged about the upper end portion of the crucible assembly. The secondary electromagnetic energy source is stationary and fixed to the upper end portion of the crucible assembly. The system includes a primary current controller configured to provide electric current to the primary electromagnetic energy source. The system includes a secondary current controller configured to provide electric current to the secondary electromagnetic energy source. The system includes a master controller configured to receive process inputs from the primary current controller and the secondary current controller and to provide current settings to each of the primary current controller and the secondary current controller based on the process inputs. The master controller is further configured to communicate with a main VAR furnace controller. The process inputs may include position of the primary electromagnetic energy source and electric current being provided to each of the primary electromagnetic energy source and the secondary electromagnetic energy source and magnetic fields generated by the primary electromagnetic energy source and the secondary electromagnetic energy source are localized to an arc region during remelting.

Still another vacuum arc remelting (VAR) system for forming an ingot from an electrode is provided that includes a crucible assembly configured to accommodate the electrode and the ingot. The crucible assembly includes an upper end portion and a lower end portion. The system includes an axial electromagnetic energy source wound about a longitudinal axis of the crucible assembly. The system includes a primary electromagnetic energy source arranged about the crucible assembly. The primary electromagnetic energy source and the crucible assembly are configured to move relative to one another along a longitudinal axis of the crucible assembly. The system includes a secondary electromagnetic energy source arranged about the upper end portion of the crucible assembly. The secondary electromagnetic energy source is stationary and fixed to the upper end portion of the crucible assembly.

In one or more forms, the system includes a current controller configured to provide electric current to the primary electromagnetic energy source. The current controller is configured to maintain current provided to the primary electromagnetic energy source and increase the current provided to the primary electromagnetic energy source. The current provided to the primary electromagnetic energy source is increased according to ingot height.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a schematic view of a vacuum arc remelting furnace in accordance with one or more implementations of the present disclosure;

FIG. 2A is a perspective view of a support assembly constructed in accordance with one or more implementations of the present disclosure;

FIG. 2B is a side view of the support assembly of FIG. 2A, illustrating a crucible mounted therein;

FIG. 3A is a partial top view of a vacuum arc remelting furnace in accordance with one or more implementations of the present disclosure;

FIG. 3B is a partial top view of a vacuum arc remelting furnace in accordance with one or more implementations of the present disclosure;

FIG. 4A is a schematic of a controller architecture in accordance with the teachings of the present disclosure;

FIG. 4B is a schematic of a controller in accordance with the teachings of the present disclosure;

FIG. 4C is a schematic of a controller in accordance with the teachings of the present disclosure;

FIG. 5 is a graph illustrating the current in each of the primary electromagnetic energy source and the secondary electromagnetic energy source being in phase in accordance with the teachings of the present disclosure;

FIG. 6 is a graph illustrating saturation of different coil architectures in accordance with the teachings of the present disclosure;

FIG. 7 is a graph indicative of coil current and indications in accordance with the teachings of the present disclosure; and

FIG. 8 is a method in accordance with the teachings of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

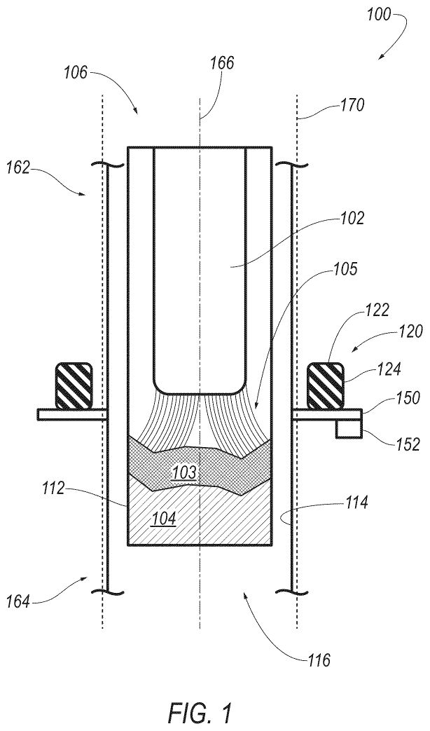

Referring to FIG. 1 a vacuum arc remelting (VAR) system 100 (also commonly referred to as a VAR furnace) is shown in accordance with one or more implementations of the present disclosure. The VAR system 100 is used to gradually melt an electrode 102 to form a pool of molten metal 103 during the remelting process, which cools to form an ingot 104, described in greater detail below. The VAR system 100 includes a crucible assembly 106 that is configured to accommodate the electrode 102 and the ingot 104. As further shown, the crucible assembly includes an upper end portion 162 and a lower end portion 164.

The crucible assembly 106 accommodates the electrode 102 and holds the ingot 104 formed from the electrode 102. The crucible assembly 106 includes a crucible 112 and a cooling member 114 that defines a chamber 116 around the crucible 112 for receiving a coolant, such as water, to reduce the temperature of the crucible 112. Other suitable systems for cooling the crucible may also be used and are within the scope of the present disclosure.

During the remelting process, electrical arcs that function to melt the electrode 102 extend between the electrode 102 and the molten metal 103, or the ingot 104, generally defining an arc region 105 as shown. As described herein, the magnetic fields generated by an electromagnetic energy source are localized to this arc region 105 or the magnetic fields generated by an electromagnetic energy source are generated near the arc region 105, pushing the arc outwards towards the crucible 112 thereby resulting in improved surface quality of the ingot 104 and reducing the weight of electrode remnant at the end of the remelting process. Additional details regarding systems for localizing the electromagnetic energy source are illustrated and described in U.S. Pat. No. 11,434,544, which is commonly owned with the present application and the contents of which are incorporated herein by reference in their entirety.

For example, an electromagnetic energy source (e.g., electromagnetic energy source 120) is translated along a longitudinal axis 166 at a height/location associated with the arc region. The height may be based on a location of the ingot, which may be determined based on a weight of the ingot. In addition, a conventional axial winding 170 with respect to longitudinal axis 166 is disposed between the electromagnetic energy source 120 and the crucible assembly 106. This conventional axial winding 170 creates an electromagnetic field along the longitudinal axis 166 for stirring the molten metal 103 and for constricting the arc below the electrode 102. Or moving the arc away from the crucible. The height of the electromagnetic energy source (e.g., electromagnetic energy source 120) with respect to a centroid of the electromagnetic energy source and the bottom of the crucible 112 may be the same or nearly the same as the height of the arcing surface of the electrode 102 (e.g., the bottom surface of the electrode 102) with respect to the bottom of the crucible 112. As the electrode 102 melts to form the ingot 104, the electromagnetic energy source 120 is translated along axis 166 to maintain a similar height. It should be appreciated that the speed of translation may be faster or slower than the change in height of the bottom of the electrode 102 with respect to the crucible 112. The electromagnetic energy source 120 may also be aligned with the gap between the electrode 102 and the ingot 104, the molten metal 103, the ingot 104, or somewhere there between and translate along the axis 166 as the electrode 102 melts. The electromagnetic energy source 120 is also aligned above the bottom melting surface of the electrode 102. The electromagnetic energy source 120 is shown situated on a support 150. The support 150 includes a sensor 152 (e.g., a distance sensor for measuring quantity of travel or position of the support 150 and electromagnetic energy source 120). The platform is part of a linear drive assembly configured to raise and lower the electromagnetic energy source along the longitudinal axis 166, which is described in greater detail below.

The electromagnetic energy source 120 may include windings 122. For example, wires are wound around a core 124 to form an electromagnet. The wires may be insulated to prevent cross conduction between windings. Additional sets of windings may be layered among winding 122 to form distinct current paths, allowing for an increased electromagnetic field energized from power sources (e.g., controllers, drivers) of predetermined capacities (e.g., maximum current rating). In one form, the electromagnetic energy source 120 has a toroidal or substantially toroidal shape. For example, cores (e.g., core 124) are toroidal or substantially toroidal and form one or more portions of a toroid. The windings (e.g., windings 122) of the electromagnetic energy source 120 may also be toroidal and form one or more portions of a toroid. These and other variations of electromagnetic energy should be construed as falling within the scope of the present disclosure.

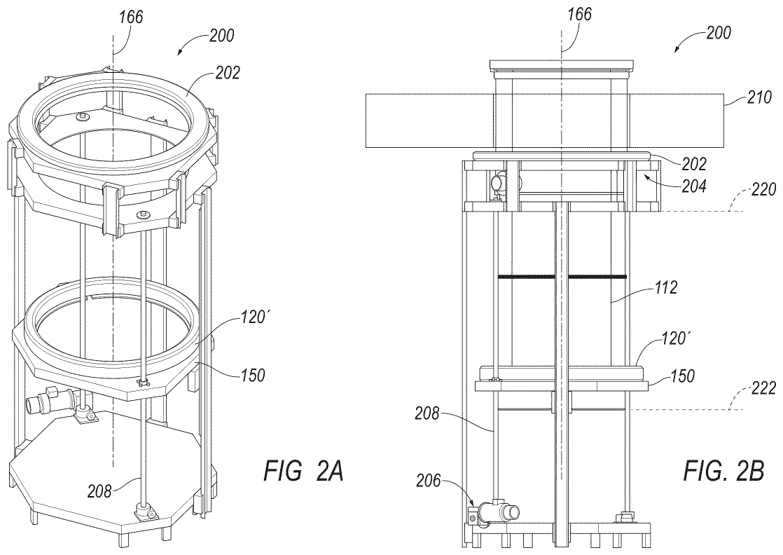

Referring to FIGS. 2A-2B, a support assembly 200 is shown in accordance with one or more implementations of the present disclosure. The support assembly 200 is constructed from a non-magnetic material (e.g., stainless steel) so as to not interfere with the generated electromagnetic fields described herein. The support assembly 200 is generally configured to orient the electromagnetic energy source 120 about the crucible 112. More specifically, the support assembly 200 is configured to mount and support both a primary electromagnetic energy source 120′ and a secondary electromagnetic energy source 202 about the crucible 112. Further, both the primary and secondary electromagnetic energy sources 120′, 202 are coaxial with the longitudinal axis 166 in this form of the present disclosure. The support assembly 200 further includes another platform (e.g., platform 204) to support the secondary electromagnetic energy source 202, which is fixed. Thus, the primary electromagnetic energy source 120′ and the crucible assembly 160 are configured to move relative to one another along the longitudinal axis 166, while the secondary electromagnetic energy source 202 is stationary and fixed to the upper end portion 164 of the crucible assembly 160.

The support assembly 200 generally defines a maximum travel height 220 and a minimum travel height 222 for the primary electromagnetic energy source 120′. Thus, the secondary electromagnetic energy source 202 is generally situated beneath a barrier or floor 210. For example, the top of the crucible 112 is accessible from a walking platform or floor 210, which is generally made of concrete. The support assembly 200 is secured to the floor 210, supported by stanchions or otherwise. In this manner, the secondary electromagnetic energy source 202 is configured to provide additional electromagnetic energy to melt the electrode 102 in an area that was previously unreachable by the translating primary electromagnetic energy source 120′. The maximum travel height may be indicated by a sensor (e.g., sensor 152) which may be situated and oriented to indicate a limit of the travel by physical contact with one or more portions of the support assembly 200.

As further shown, the support assembly 200 may include one or more actuators (e.g., electric motor 206, screw drive 208, support channels) that forms an actuator assembly (e.g., a linear drive assembly). For example, the electric motor 206 drives one or more screw drives 208 configured to translate the primary electromagnetic energy source 120′. The linear drive assembly is part of a more general lift mechanism/system, which is controlled by the vacuum arc remelting (VAR) system 100 as set forth in greater detail below.

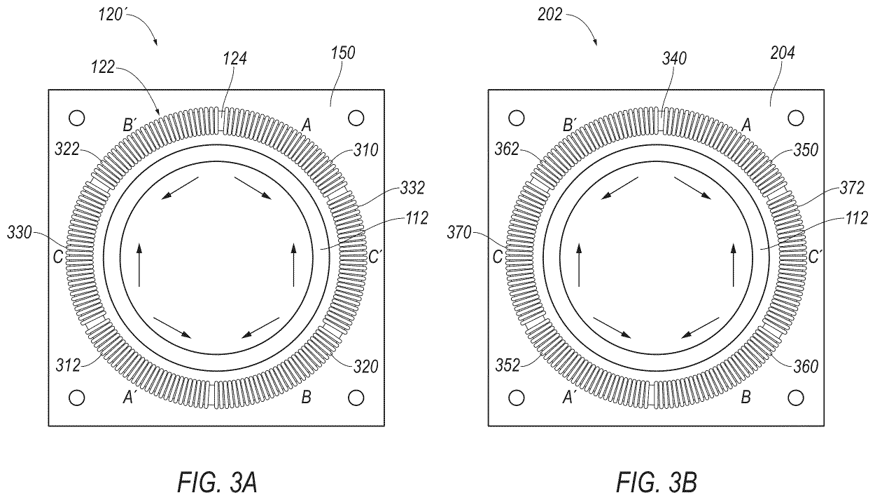

Referring to FIG. 3A, a partial top view of a VAR system 100 is shown in accordance with one or more implementations of the present disclosure. The system 100 includes one or more electromagnetic energy sources (e.g., primary electromagnetic energy source 120′). The primary electromagnetic energy source 120′ includes windings 122, which may be coils (e.g., coiled wire) wrapped around the core 124. The windings 122 are configured in segments (e.g., segments 310, 312, 320, 322, 330, 332). The segments are generally paired (e.g., coil pair A-A′; coil pair B-B′; and coil pair C-C′), where the coils of each pair are arranged on opposite sides of the core. For example, segment 310 is opposite segment 312 relative the crucible 112 to form a pair. Segment 320 is opposite segment 322 relative the crucible 112 to form another pair along with segment 330 being opposite segment 332 relative the crucible 112 to form another pair. Each segment 310, 312, 320, 322, 330, 332 is insulated or non-conductive with other segments 310, 312, 320, 322, 330, 332 and is energized with current having an opposite polarity from adjacent segments. Each coil pair is configured to receive a sinusoidal current, with the current in each pair being 120° out of phase. The direction of the magnetic field from each individual pair is represented by the arrows in FIGS. 3A-B. Once all three pairs are activated, the resultant magnetic field is rotational, with rotations per minute dictated by the time period of the sinusoidal current.

Referring to FIG. 3B, another partial top view of a VAR system 100 is shown in accordance with one or more implementations of the present disclosure, this time with the secondary electromagnetic energy source 202, which has a similar arrangement (e.g., second set) of segments. For example, as shown, the secondary electromagnetic energy source 202 includes a core 340 and segments 350, 352, 360, 362, 370, 372. The segments are paired (e.g., coil pair A-A′; coil pair B-B′; and coil pair C-C′), where the coils of each pair are arranged on opposite sides of the core). For example, segment 350 is opposite segment 352 relative the crucible 112 to form a pair. Segment 360 is opposite segment 362 relative the crucible 112 to form another pair along with segment 370 being opposite segment 372 relative the crucible 112 to form another pair.

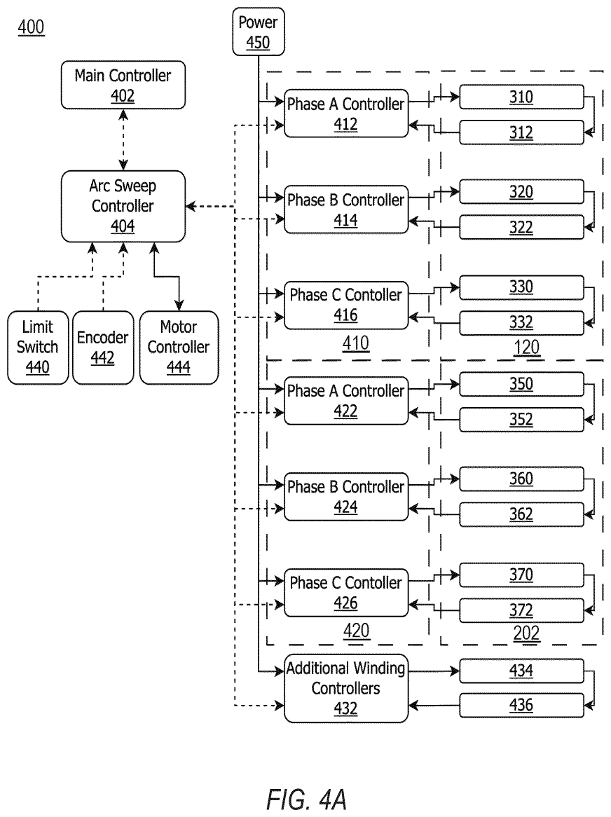

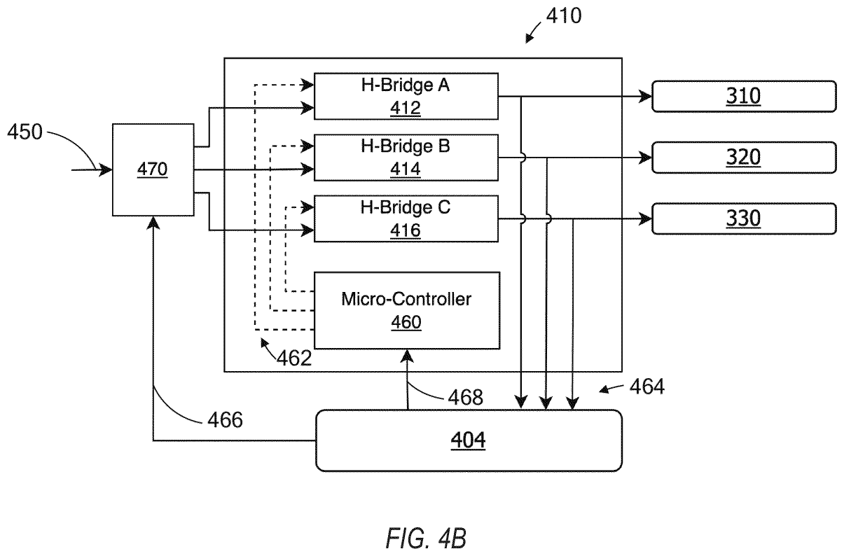

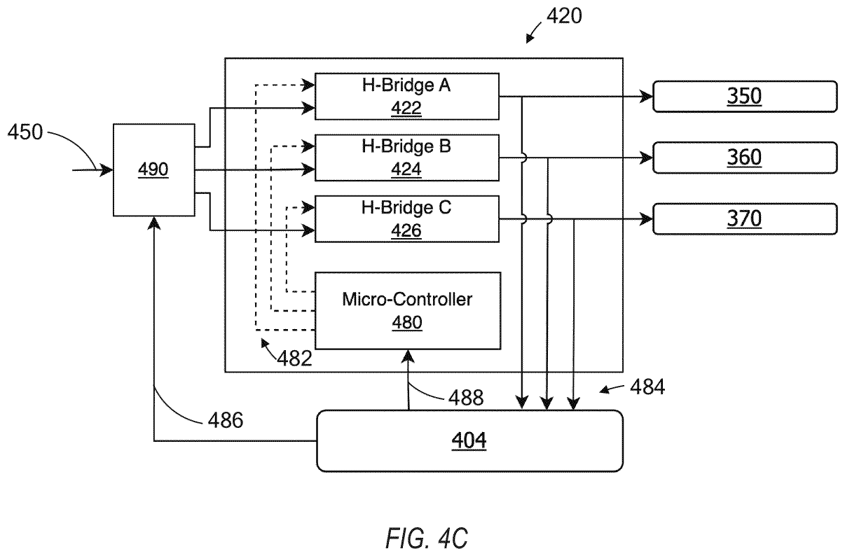

For example, and as shown with regard to FIG. 4A, in accordance with one or more implementations of the present disclosure, each of the primary electromagnetic energy source 120′ and secondary electromagnetic energy source 202 are powered by one or more controllers (e.g., primary controller 410, secondary controller 420) in a controller architecture 400. For example, primary electromagnetic energy source 120s is powered by the primary controller 410 and the secondary electromagnetic energy source 202 is powered by the secondary controller 420. The primary controller 410 and the secondary controller 420 may include phase controllers (e.g., phase controllers 412, 414, 416, 422, 424, 426).

Although designated as distinct entities, the controllers (e.g., primary controller 410, secondary controller 420, phase controllers 412, 414, 416, 422, 424, 426) may be situated in one support assembly, board, card, or otherwise. All of the controllers described herein may be based on one or more processors. The controllers may be distributed. The controllers (e.g., phase controllers 412, 414, 416, 422, 424, 426) receive current (e.g., alternating current, direct current) from a power source 450. For direct currents, the controller (e.g., phase controllers 412, 414, 416, 422, 424, 426) may include an H-bridge for creating an alternating current from the received direct current.

A current (e.g., direct current) is received from the power source 450. For example, a first phase (e.g., phase A) is used to energize segments 310, 312, 350, 352. A second phase (e.g., phase B) is used to energize segments 320, 322, 360, 362. A third phase (e.g., phase C) is used to energize segments 330, 332, 370, 372. Further, additional windings may be used to increase the electromagnetic field generated by the primary and secondary electromagnetic energy sources 120′, 202. For example, the additional winding controller(s) 432 is used to incrementally increase the provided electromagnetic field with additional windings. The additional winding controllers 432 have the same form factor as controllers 412, 414, 416, 422, 424, 426, providing scalability for larger electromagnetic fields to be generated with the same hardware type.

For example, an additional winding controller 432 provides electric current for additional windings or segments 434, 436 which may be double wound in segment A-A′. For example, the primary electromagnetic energy source 120′ includes a second winding on one or more segments (e.g., segments 310, 312, 320, 322, 330, 332). That is, the additional winding controller 432 provides current to a second set of windings that are wrapped in combination with windings for segment 310 and segment 312. In such a way, additional current is used to generate larger magnetic fields by duplicating controller hardware using independent circuits.

The main controller 402 (e.g., a main VAR furnace controller) receives process parameters (e.g., a recipe) for remelting and provides status information to an HMI (Human Machine Interface). For example, the main controller 402 indicates (e.g., displays on the HMI) the position of the primary electromagnetic energy source 120 based on an indication of position from position sensor 442 (e.g., an encoder). The HMI may further depict the remelt location of the electrode 102, the current provided to one or more of electromagnetic energy source 120, 202, segment 310, 312, 320, 322, 330, 332, 350, 352, 360, 362, 370, 372, 434, 436, or a combination thereof. The main controller 402 directs the remelt process and notifies the arc sweep controller 404 that arc position control in the crucible 112 is desired. The main controller 402, the arc sweep controller 404, or combinations thereof are considered a master controller as they provide instructions to controllers that are downstream (e.g., receiving commands or inputs from upstream controllers). Communication between controller 402 and controller 404 may be provided through an Ethernet protocol. It should be understood, however, that other communications protocols, such as by way of example, transmission control protocol and internet protocol (TCP/IP), user datagram protocol (UDP), or controller area network (CAN) protocol may be employed while remaining within the scope of the present disclosure.

The arc sweep controller 404 provides the position of the primary electromagnetic energy source, the current provided to the primary and secondary electromagnetic energy sources 120′, 202, alarms, or combinations thereof. The arc sweep controller 404, or another controller, receives process inputs from one or more controller (e.g., main controller 402, primary controller 410, secondary controller 420). The arc sweep controller 404, or another controller, provides current settings to other controllers (e.g., the primary controller 410, the secondary controller 420), and those controllers control the output of the current allowed to flow between the power source 450 and the primary and secondary electromagnetic energy sources 120′, 202. The process inputs may include encoder position and current provided to the primary and secondary electromagnetic energy sources 120′, 202.

The arc sweep controller 404 receives an indication (e.g., an analog or digital input) provided by a limit switch (e.g., limit switch 440). More than one indication corresponding to multiple limit switches is contemplated. For example, each limit switch 440 may be configured to provide an indication when energy to the motor controller 444 should cease, ensuring that travel of the primary electromagnetic energy source 120′ is within a predetermined range. The limit switches 440 may be disposed on the support assembly 200 at the intended maximum height and minimum height of the primary electromagnetic energy source 120 or the intended maximum height (e.g., maximum travel height 220) and minimum height (e.g., minimum travel height 222) of the support 150 for the primary electromagnetic energy source 120′.

One or more position sensors (e.g., position sensor 442) are used to determine a position of the primary electromagnetic energy source 120′ as it moves longitudinally along the crucible 112 (e.g., longitudinal axis 166). The position sensors may be part of the electric motor 206. For example, the position sensors (e.g., position sensor 442) may measure an angular position in steps or otherwise of the output rotor of the electric motor. An additional sensor (e.g., sensor 152) may be attached to, or proximate, the support 150, which may be used alone or in combination with the other position sensors 442 to measure the position of the primary electromagnetic energy source 120′. Position sensors may also be used to measure the angular position of one or more screw drives 208. For example, the linear position of the screw drives 208 may be indictive of the movement of the primary electromagnetic energy source 120′ along the longitudinal axis 166 when considered in combination with the screw pitch or other information.

For example, the arc sweep controller 404 determines a numerical position (e.g., height) needed for the primary electromagnetic energy source 120′ to properly control the arc relative the bottom of the electrode 102. The arc sweep controller 404 then converts the numerical position into a quantity of steps to advance the electric motor 206 or screw drive 208 based on the position of the position sensor (e.g., position sensor 442) or until the position sensor reaches the desired destination. For example, the arc sweep controller 404 may be configured to track a position associated with the electrode 102 (e.g., bottom surface of the electrode 102) with a position of the primary electromagnetic energy source 120′ using a conversion between the position sensor 442 and a position associated with the electrode 102, continuously reducing a difference between the position of the primary electromagnetic energy source 120′ based on the position sensor and the position associated with electrode 102. The position associated with the electrode 102 may be the ingot height, which may be derived from the ingot weight.

The primary and secondary electromagnetic energy sources 120′, 202 may cause interference between their respective generated electromagnetic fields. For example, if the current or voltage associated with segment A of primary electromagnetic energy source 120′ (e.g., segment 310) is out of phase with the current or voltage associated with segment A of secondary electromagnetic energy source 202 (e.g., segment 350), the field associated with secondary electromagnetic energy source 202 may interfere, conflict, reduce, or otherwise impede the field associated with the primary electromagnetic energy source 120′.

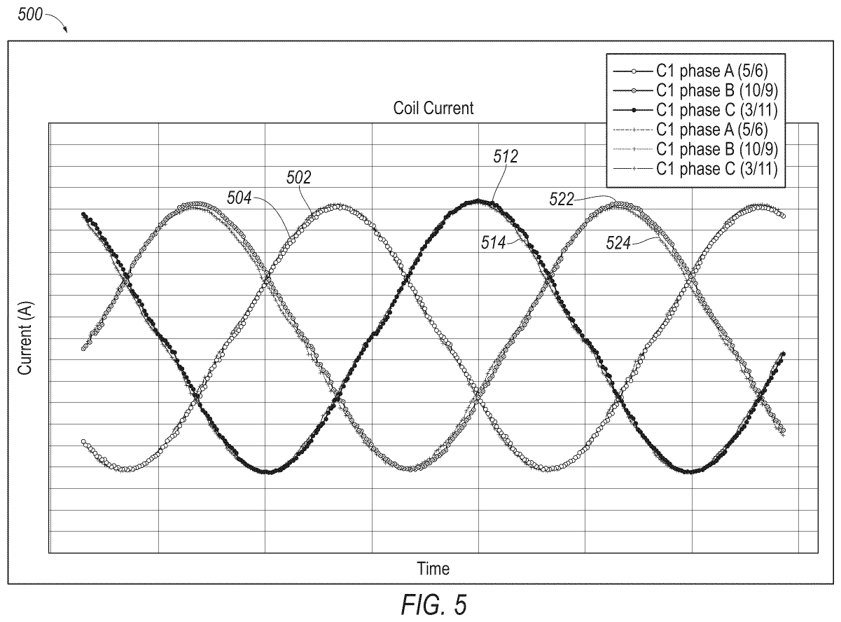

Referring to FIG. 4B, a controller is shown in accordance with one or more implementations of the present disclosure. It should be understood that the term “controller” is generally a depiction of the primary controller 410, the secondary controller 420, or another controller indicated (e.g., controller 432 or phase controllers). The controller 410 receives commands from the arc sweep controller 404. For example, the arc sweep controller 404 may provide an indication through an output (e.g., a digital or analog voltage output) to an input 468 associated with microcontroller 460. The microcontroller 460 receives that input as an indication to energize one or more of the phase controllers 412, 414, 416. A similar control signal may be sent to the secondary controller 420 for phase synchronization as discussed with regard to FIG. 5 for energization of phase controllers 422, 424, 426. Secondary controller 420 and phase controllers 422, 424, 426 have a similar construction to that shown with regard to primary controller 410 and phase controllers 412, 414, 416. Phase controllers 422, 424, 426 may receive a power, current, or voltage input from controller 470 or counterpart controller, or be operated by a counterpart controller similar to microcontroller 460 from instructions provided by arc sweep controller 404. Outputs from the phase controllers 422, 424, 426 are monitored and provided to the arc sweep controller 404 for control and operation of phase controllers 412, 414, 416, 422, 424, 426.

In this form, the microcontroller 460 is configured to operate the H-bridge of the phase controllers 412, 414, 416. For example, the microcontroller operates switches of the H-bridge, or half bridge(s), to generate an alternating current from a direct current provided from source 450. The switches may be pulse-width modulated (PWM) to form the sinusoidal alternating currents shown in FIG. 5. For example, the microcontroller 460 operates the switches for the H-bridge associated with phase controller 412 with a 120° offset from the switches for the H-bridge associated with phase controller 414 and 240° offset from the switches for the H-bridge associated with phase controller 416, providing three-phases as indicated in FIG. 5. The phase controllers 422, 424, 426 are similarly operated to provide current waveforms 502, 504, 512, 514, 522, 524.

The magnitude of each peak generated by the H-bridge phase controllers 412, 414, 416 are controlled by controller 470. The magnitude of each peak generated is controlled using controller 470 to balance peak currents of each phase and control the peak current output by the phase controllers 412, 414, 416, 422, 424, 426. For example, controller 470 receives an indication of desired power, current, voltage or combination thereof indication (e.g., indication 466). The indication 466 may be provided as a numeral value, a percentage of total power, or otherwise. For example, the controller 470 may receive a voltage within the range of 0-10 Volts, and the controller 470 may scale the output power, current, or voltage from 0-100% based on the indication (e.g., indication 466). The indication 466 is used to control the power, voltage, or current provided to respective H-bridges of phase controllers 412, 414, 416, 422, 424, 426. The indication 466 may be an analog voltage output from controller 404 to an analog input of controller 470 between 0.0-10 Volts and corresponding to and output of 0-400 Volts or 0-10 Amps of the controller 470. The indication 486 may also be between 0.0-5.5 Volts and corresponding to and output of 0-400 Volts or 0-10 Amps of the controller 470.

Taps 464 are provided to measure the power, voltage, current, or resistances of each of the coils or phases. For example, controller 404 may be configured to receive taps 464 as shown, providing an indication of the voltage, current, or power provided to segments 310, 312, 320, 322, 330, 332, 350, 352, 360, 362, 370, 372. Controller 404 may be further configured to monitor a current loop based on segments 310, 312, 320, 322, 330, 332, 350, 352, 360, 362, 370, 372. For example, a current loop (not shown) is formed between segments 310, 312 for measuring a resistance associated with those segments before remelting commences. The measured resistance may be used to ensure similar current, or voltage, peaks are formed and provided to the segments 310, 312, 320, 322, 330, 332 such that the resulting electromagnetic fields generated by the primary electromagnetic energy source 120 are balanced between segments.

For example, manufacturing and use may impart variations between segments 310, 312, 320, 322, 330, 332 and cause generated fields to have unequal magnitudes, which can result in reduced arc control or unbalanced arcing with respect to the longitudinal axis 166. As such, the resistances of current loops are measured by the controller 404 and used to adjust power, current, or voltage output from controller 470 based on indication 466. The power, current, or voltage provided to segments 310, 312, 320, 322, 330, 332 may be based on the resistance of the current loop associated with one or more segments 310, 312, 320, 322, 330, 332.

Referring to FIG. 4C, a controller is shown in accordance with one or more implementations of the present disclosure. It should be understood that the term “controller” is generally a depiction of the primary controller 410, the secondary controller 420, or another controller indicated (e.g., controller 432 or phase controllers). The controller 420 receives commands from the arc sweep controller 404. For example, the arc sweep controller 404 may provide an indication through an output (e.g., a digital or analog voltage output) to an input 488 associated with microcontroller 480. The microcontroller 480 receives that input as an indication to energize one or more of the phase controllers 422, 424, 426.

In this form, the microcontroller 480 is configured to operate the H-bridge of the phase controllers 422, 424, 426. For example, the microcontroller operates switches of the H-bridge to generate an alternating current from a direct current provided from source 450. The switches may be pulse-width modulated (PWM) to form the sinusoidal alternating currents shown in FIG. 5. For example, the microcontroller 480 operates the switches for the H-bridge, or half bridge(s), associated with phase controller 422 with a 120° offset from the switches for the H-bridge associated with phase controller 424 and 240° offset from the switches for the H-bridge associated with phase controller 426, providing three-phases as indicated in FIG. 5.

The magnitude of each peak generated by the H-bridge phase controllers 422, 424, 426 are controlled by controller 490. The magnitude of each peak generated is controlled using controller 490 to balance peak currents of each phase and control the peak current output by the phase controllers 422, 424, 426. For example, controller 490 receives an indication of desired power, current, voltage or combination thereof indication (e.g., indication 486). The indication 486 may be provided as a numeral value, a percentage of total power, or otherwise. For example, the controller 490 may receive a voltage within the range of 0-10 Volts and the controller 490 may scale the output power, current, or voltage from 0-100% based on the indication (e.g., indication 486). The indication is used to control the power, voltage, or current provided to respective H-bridges of phase controllers 422, 424, 426. For example, controller 420 may support voltages from zero to 400 Volts and currents from 0 to 10 Amps. The indication 486 may be an analog voltage output from controller 404 to an analog input of controller 490 between 0.0-10 Volts and corresponding to and output of 0-400 Volts or 0-10 Amps of the controller 490. The indication 486 may also be between 0.0-5.5 Volts and corresponding to and output of 0-400 Volts or 0-10 Amps of the controller 490.

Taps 484 are provided to measure the power, voltage, current, or resistances of each of the coils or phases. For example, controller 404 may be configured to receive taps 484 as shown, providing an indication of the voltage, current, or power provided to segments 310, 312, 320, 322, 330, 332, 350, 352, 360, 362, 370, 372. Controller 404 may be further configured to monitor a current loop based on segments 310, 312, 320, 322, 330, 332, 350, 352, 360, 362, 370, 372. For example, a current loop (not shown) is formed between segments 350, 352 for measuring a resistance associated with those segments before remelting commences. The measured resistance may be used to ensure similar current, or voltage, peaks are formed and provided to the segments 350, 352, 360, 362, 370, 372 such that the resulting electromagnetic fields generated by the primary electromagnetic energy source 202 are balanced between segments.

For example, manufacturing and use may impart variations between segments 350, 352, 360, 362, 370, 372 and cause generated fields to have unequal magnitudes, which can result in reduced arc control or unbalanced arcing with respect to the longitudinal axis 166. As such, the resistances of current loops is measured by the controller 404 and used to adjust power, current, or voltage output from controller 490 based on indication 486. The power, current, or voltage provided to segments 350, 352, 360, 362, 370, 372 may be based on the resistance of the current loop associated with one or more segments 350, 352, 360, 362, 370, 372.

As shown in accordance with one or more implementations of the present disclosure, FIG. 5 illustrates the alignment of phases for respective segments of the primary and secondary electromagnetic energy sources 120′ and 202. For example, segments 310, 312, 350, 352 have aligned phases and magnitude as shown with current waveforms 502, 504 that are shown in phase or substantially in phase (e.g., less than 30° out of phase). Segments 320, 322, 360, 362 have aligned phases as shown with current waveforms 512, 514 that are shown in phase or substantially in phase (e.g., less than 30° out of phase). Segments 330, 332, 370, 372 have aligned phases as shown with current waveforms 522, 524 that are shown in phase or substantially in phase (e.g., less than 30° out of phase).

As the primary electromagnetic energy source 120′ nears the maximum travel height (e.g., nears the location of one or more limit switches 440), the arc sweep controller 404 sends commands or otherwise causes the phase controllers (e.g., phase controllers 412, 414, 416) to increase current supplied to respective segments (e.g., segments 310, 312, 320, 322, 330, 332). Thus, the electrode 102 is continually remelted as the primary electromagnetic energy source 120′ reaches the maximum travel height 220, as indicated by limit switch 440 or position sensor 442. As the primary electromagnetic energy source 120′ reaches the maximum travel height 220, the current applied to the primary electromagnetic energy source 120′ (e.g., segments 310, 312, 320, 322, 330, 332) is increased. The increase may be exponential over ingot height (e.g., more exponential than linear) until the primary electromagnetic energy source 120′, or segments thereof, reach magnetic field saturation.

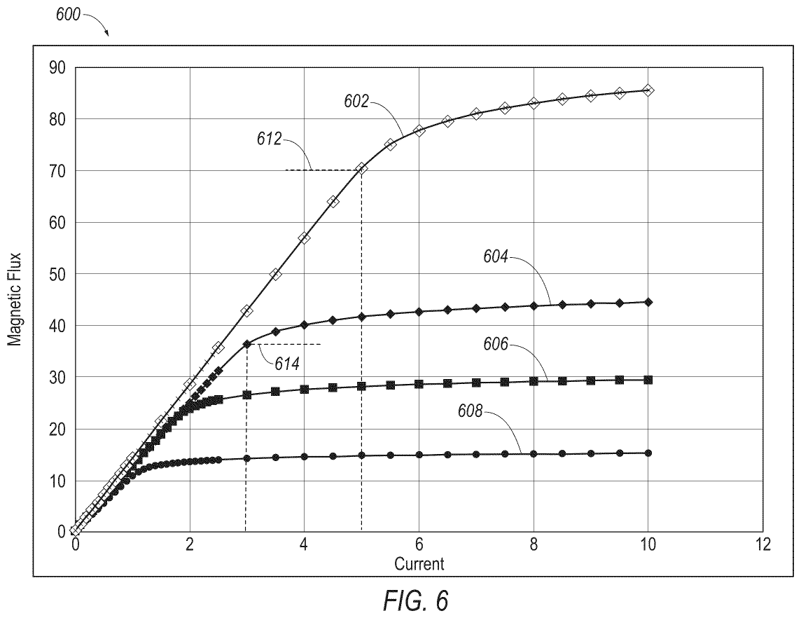

More specifically, and referring to FIG. 6, the magnetic field strength of distinct coil architectures 602, 604, 606, 608 with the applied peak current through respective windings are shown. For example, a coil architecture 602 is considered to reach saturation when a flat or level current is reached. The level current is equal to a predetermined ratio between applied current and the resulting magnetic field. For example, a predetermined rate is expected for a coil architectures (e.g., a ratio of 3:2 indicative of resultant magnetic field to applied current). That is, the level current may be defined as when the expected resultant magnetic field is only 70% of the 3:2 ratio. As such, the current may be increased to a predetermined amount (e.g., 0.8 Amperes), until the expected ratio between current and magnetic field has decreased by 70% from typical (e.g., 3:2 to 2:2). In such a way, current applied to the electromagnetic energy source 120 may be increased to a practical saturation level that is less than an absolute saturation level to ensure an efficiency is maintained. Current may be increased until a setpoint is reached. For example, the setpoint may be between 0.1 Amps and 0.4 Amps. For example, coil architecture 602 may have a saturation point 612 defined when the relationship between applied current and resulting field becomes non-linear as shown. With respect to coil architecture 604, the saturation point 614 is defined when the relationship between applied current and resulting field becomes non-linear as shown. The current may be exponentially increased to 70 Gauss or less than 70 Gauss depending on the coil architecture.

Current may be controlled by controller 470 as discussed herein before sinusoidal waveforms are generated. The coil current (e.g., current applied from one or more of phase controllers 412, 414, 416, 422, 424, 426, 432) may be step increased, ramp increased (e.g., more linearly than exponentially), or exponentially increased (e.g., more exponentially than linearly) to the practical saturation level or the absolute saturation level as the electromagnetic energy source 120 reaches the limit switch 440 or a predetermined height (e.g., maximum travel height 220) based on the position sensor 442.

Current provided to the secondary electromagnetic energy source 202 is be increased as the predetermined height (e.g., maximum travel height 220) is reached. For example, the arc sweep controller 404 provides commands to phase controllers (e.g., phase controllers 422, 424, 426) to increase the supplied current to segments (e.g., segments 350, 352, 360, 362, 370, 372) according to an indication based on the limit switch 440, location based on the position sensor 442, a combination thereof, or otherwise.

For example, the current supplied to the secondary electromagnetic energy source 202 may be step increased, ramp increased, or exponentially increased based on the indication that the primary electromagnetic energy source 120 has reach a predetermined height (e.g., a height indicated by limit switch 440 or position sensor 442). The current applied to the secondary electromagnetic energy source 202 (e.g., current applied with controller 424) is in-phase with current applied to respective segment of the primary electromagnetic energy source 120′ (e.g., current applied with controller 412) such that the resulting fields from segments 310, 312 are in-phase with resulting fields from segments 350, 352, reducing interference or cancellation of resulting fields from coils situated at the same radial or angular positions about the crucible 112. The phase controllers (e.g., phase controllers 412, 414, 416, 422, 424, 426, 432) include circuitry to adjust the phase of the incoming signal to reduce interference or cancellation of resulting fields.

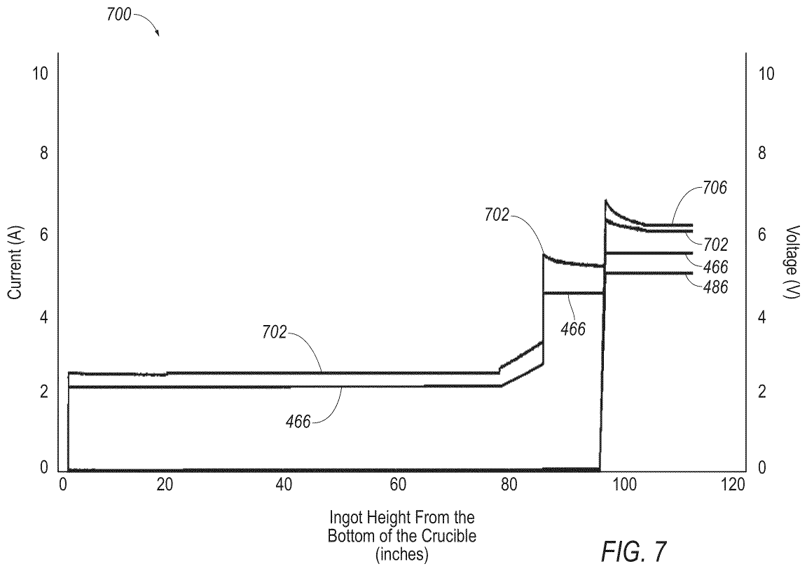

Referring to FIG. 7, a graph illustrating coil current 702, 706 and indications 466, 486 is shown in accordance with the teachings of the present disclosure. The coil current 702 may be a root sum of squares (RSS) value from currents 502, 512, 522 and the coil current 706 may be a root sum of squares (RSS) value from currents 504, 514, 524. The magnitude of current through the primary electromagnetic energy source 120′ and the magnitude of current through the secondary electromagnetic energy source 202 is shown with respect to a height of the ingot in inches during the remelting process.

The current 702 associated with the primary electromagnetic energy source 120′ and the current 706 associated with the secondary electromagnetic energy source 202 is shown on the vertical axis with respect to ingot height on the horizontal axis. For example, current 702 may be the current output by controller 470 and current 706 may be the current output by controller 490. As the electrode 102 is melted, the ingot 104 increases in mass and is deposited in the crucible 106. The mass of the ingot 104 is measured, which is indicative of a height of the ingot 104 and the height of the electrode 102. Ingot height may be determined as a percentage of ingot height. For example, the percentage of ingot height may be determined by a measured weight or mass of the electrode 102 before remelting compared against the current weight of the ingot 104 (e.g., current measured weight of the ingot 104 during remelt divided by the original weight of the electrode 102 before remelt).

Indications 466, 486 are provided as described herein to adjust the current 702 provided by controller 470 to be conducted through the primary electromagnetic energy source 120′ and the current 706 provided by controller 490 to be conducted through the secondary electromagnetic energy source 202 as a function of the height of the ingot 104, the weight of the ingot 104, the height of the bottom of the electrode 102, or a combination thereof. The height of the ingot 104 and the height of the electrode 102 may be determined based on a weight of the ingot 104, a weight of the crucible assembly 106 including the ingot 104, or a weight of the crucible 112 including the ingot 104.

The indications 466, 486 may be derived through conditional statements or case statements (e.g., instructions executable by one or more controller or processors thereof). For example, in one or more steps, controller 404 may determine whether the ingot height, as a function of ingot weight or otherwise, is between a first conditional minimum and a first conditional maximum (e.g., greater than or equal to zero and less than 80 inches of ingot height). For example, the first conditional minimum may be 0.0 inches and the first conditional maximum may correspond with the sensor 152 being activated at around 80 inches of ingot height. As shown in FIG. 7, the current 702 is set to 2.0 amps based on indication 466 being set to 2.0, on a scale from 0.0 to 5.5 of current supported by controllers 410, 420. Each Volt of indication 466 may also correspond to 60 Volts of output. For example, a 2.0 Volt indication may correspond to 120 Volts of output for controller 470.

Current 702 may be indicative of a peak current in the primary electromagnetic energy source 120′ or a root sum of squares squared value of current in the primary electromagnetic energy source 120′. In one or more steps, controller 404 may determine whether the ingot height is greater than the first conditional maximum and less than a second conditional maximum (e.g., 86 inches of an expected 120-inch ingot at the completion of remelting). If the condition is true, a factor may be calculated. The factor may be based on the ingot height (e.g., between 80 inches and 86 inches) less a constant (e.g., 76.0) and divided by 32.5, as shown in Equation 1 below. With the determined factor, the indication 466 provided to the controller 470 may be exponentially increased from the scaler as shown in Equation 2.

$$factor = \frac{{ingot}_{h e i g h t} - 76.0}{32.5} \qquad ( 1 )$$

$${Indication}_{466} = scalar * {e}^{factor} \qquad ( 2 )$$

where the scalar may be equal to the value of the preceding step (e.g., 2.0) and the factor is based on the ingot height and one or more constants.

In one or more steps, the controller 404 may determine whether the ingot height is greater than 86 inches and less than a second minimum indicative of a need to supply current to the second electromagnetic energy source 202. If ingot height is greater than 86 inches and less than the second minimum, the controller 404 may output indication 466 as 5.5, which may be indicative of the maximum output of controller 470.

In one or more steps, the controller 404 may determine whether ingot height is greater than the second minimum and less a third maximum (e.g., 97 inches). If ingot height is greater than the second minimum and less than the third maximum, the controller 404 may maintain indication 466 at 5.5 and define indication 486 as a function of a scalar (e.g., 5.5) multiplied by the ingot height, as a percentage, less a constant (e.g., 96.0), as shown in Equation 3.

$${Indication}_{486} = scalar * ( {ingot}_{height} - 96.0 ) \qquad ( 3 )$$

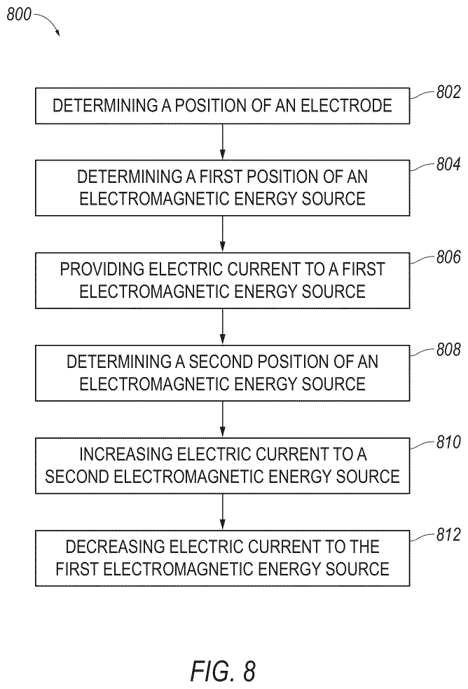

In one or more steps, the controller 404 may determine whether ingot height is greater than the third maximum and an absolute maximum of ingot height (e.g., ingot weight is equal to the measured weight of the electrode 102 before remelting). In other words, if the ingot height is greater than 97 inches and less than the maximum height, indication 466 may be set to 5.5 (e.g., the maximum current for primary electromagnetic energy source 120′) and indication 486 may be set to 5.5 (e.g., the maximum current for secondary electromagnetic energy source 202). If all of these conditions are not met, the indications 466, 486 may be set to zero. Any of the steps, or portions thereof, described with respect to FIG. 7 may be all or part of one or more steps associated with FIG. 8. For example, the current described in one more of the steps related of FIG. 8 may be determined by one or more of the steps described above.

Referring to FIG. 8, a method 800 is shown in accordance with one or more implementations of the present disclosure. Generally, the method 800 is used for melting or remelting an electrode 102 and also for controlling the current in each coil when the ingot is in between the two coils. It should be understood that the steps illustrated and further described below in method 800 may be omitted, rearranged, or duplicated while remaining within the scope of the present disclosure.

First, in step 802, the position of the electrode 102 is determined. For example, a physical location of the electrode 102 (e.g., the most bottom portion of the electrode 102) is determined relative the crucible 112 along the longitudinal axis 166. The position of the primary electromagnetic energy source 120 is based on the weight of the electrode 102. For example, as the ingot 104 is created during the remelting process, the weight of the electrode 102 is continually measured to indicate the amount of remelt performed and the amount of electrode 102 remaining, indicating the position of the electrode 102 or the bottom of the electrode 102 and top of ingot 104.

In step 804, a position of the primary electromagnetic energy source 120′ is be determined. For example, an encoder position (e.g., a position of position sensor 442) determines a position of the primary electromagnetic energy source 120′. The position of the primary electromagnetic energy source 120′ is determined relative the position of the electrode 102 determined in step 802. The relative distance between the position of the electrode 102 and the position of the primary electromagnetic energy source 120′ may be reduced (e.g., height differences relative the bottom of the crucible 112 may be reduced) to ensure proper melting or remelting of the electrode 102.

In step 806, electric current is provided to the primary electromagnetic energy source 120′. After a magnetic field is generated, current is provided to the electrode 102 to cause arc-based melting of the electrode 102 with arcs in the arc region 105. As the bottom of the electrode 102 melts, the bottom of the electrode 102, or another position of electrode 102 (e.g., edge) is determined and the differences between the height of the bottom or edge of the electrode 102 and the height of the electromagnetic energy source 120 are reduced to ensure proper melting of the electrode 102. For example, a height of the bottom of the electrode 102 is determined relative the bottom of the crucible 112 or the top of the ingot 104 and a height of the primary electromagnetic energy source 120′ is determined relative to the bottom of the crucible or the top of the ingot 104. Differences between these relative heights may be reduced by adjusting the position of the primary electromagnetic energy source 120′ with an actuator (e.g., electric motor 206, screw drive 208).

In step 808, a second position of the primary electromagnetic energy source 120′ is determined. The second position of the primary electromagnetic energy source 120′ in this case corresponds to a maximum travel height (e.g., height 220) where the primary electromagnetic energy source 120′ reaches a limit switch or a predetermined maximum height relative the support assembly 200 or the crucible 112. As the translation along longitudinal axis 166 of the primary electromagnetic energy source 120′ is limited, the magnetic field generated by primary electromagnetic energy source 120′ is increased to ensure that sufficient field is maintained in arc region 105. For example, the current supplied to the primary electromagnetic energy source 120′ may be step increased, ramp increased, or exponentially increased based on the indication that the primary electromagnetic energy source 120′ has reached a predetermined height while the electrode 102 continues to melt and the height of the bottom of the electrode 102 continues to increase as described throughout this disclosure.

In step 810, the electric current provided to the secondary electromagnetic energy source 202 is increased. For example, the current supplied to the secondary electromagnetic energy source 120 may be step increased, ramp increased, or exponentially increased based on the indication that the primary electromagnetic energy source 120′ has reached a predetermined height as described throughout this disclosure. In such a way, the arc region 105 is maintained with fields generated from both primary and secondary electromagnetic energy sources 120′, 202.

In step 812, the electric current provided to the primary electromagnetic energy source 120′ is reduced. For example, circuits providing current to the primary electromagnetic energy source 120′ may be opened by controllers (e.g., primary controller 410). The controllers (e.g., primary controller 410) further ramp down or gradually decrease current supplied to the primary electromagnetic energy source 120′. For example, the current may be reduced based on the position of the bottom of the electrode 102 or top of ingot 104.

Controllers described herein (e.g., controller 402, 404, 410, 412, 414, 416, 420,422, 424, 426, 432) may include one or more processors, microprocessors, microcontrollers, or combinations thereof and one more non-transitory, tangible computer-readable medium. The memory may store instructions in one or more languages (e.g., machine code, assembly, C, PYTHON). The instructions may be executable by the one or more processors, microprocessors, microcontrollers to implement the steps described above. For example, a case statement or conditional statement may be used to implement one or more steps associated with FIGS. 7-8. One or more steps may be part of instructions that may be compiled, require compiling, or otherwise.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

In this application, the term “controller” and/or “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components (e.g., op amp circuit integrator as part of the heat flux data module) that provide the described functionality; or a combination of some or all of the above, such as in a system-on-chip.

The term memory is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general-purpose computer to execute one or more particular functions embodied in computer programs. The functional blocks, flowchart components, and other elements described above serve as software specifications, which can be translated into the computer programs by the routine work of a skilled technician or programmer.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A vacuum arc remelting (VAR) system for forming an ingot from an electrode, the system comprising:
a crucible assembly configured to accommodate the electrode and the ingot, wherein the crucible assembly includes an upper end portion and a lower end portion;
a primary electromagnetic energy source arranged about the crucible assembly, wherein the primary electromagnetic energy source and the crucible assembly are configured to move relative to one another along a longitudinal axis of the crucible assembly; and
a secondary electromagnetic energy source arranged about the upper end portion of the crucible assembly, wherein the secondary electromagnetic energy source is stationary and fixed to the upper end portion of the crucible assembly.

2. The vacuum arc remelting (VAR) system according to claim 1, further comprising:
a primary current controller configured to provide electric current to the primary electromagnetic energy source;
a secondary current controller configured to provide electric current to the secondary electromagnetic energy source; and
a master controller configured to receive process inputs and to provide current settings to each of the primary current controller and the secondary current controller based on the process inputs, the master controller further configured to communicate with a main VAR furnace controller,
wherein the process inputs comprise position of the primary electromagnetic energy source and electric current being provided to each of the primary electromagnetic energy source and the secondary electromagnetic energy source, and
wherein magnetic fields generated by the primary electromagnetic energy source and the secondary electromagnetic energy source are localized to an arc region during remelting.

3. The vacuum arc remelting (VAR) system according to claim 2, wherein the master controller is configured to provide commands to the primary current controller to increase the electric current being provided to the primary electromagnetic energy source as the primary electromagnetic energy source reaches a predetermined height.

4. The vacuum arc remelting (VAR) system according to claim 3, wherein the electric current being provided to the primary electromagnetic energy source is increased exponentially to a saturation level at the predetermined height.

5. The vacuum arc remelting (VAR) system according to claim 4, wherein the master controller is configured to provide commands to the secondary current controller to increase the electric current being provided to the secondary electromagnetic energy source after the electric current being provided to the primary electromagnetic energy source reaches the saturation level.

6. The vacuum arc remelting (VAR) system according to claim 5, wherein the master controller is configured to provide commands to the primary current controller to switch off the electric current being provided to the primary electromagnetic energy source after the electric current being provided to the secondary electromagnetic energy source reaches a predetermined level.

7. The vacuum arc remelting (VAR) system according to claim 2, wherein the electric current being provided to both the primary electromagnetic energy source and the secondary electromagnetic energy source are in phase.

8. The vacuum arc remelting (VAR) system according to claim 2, further comprising a position sensor configured to transmit the position of the primary electromagnetic energy source relative to the crucible assembly to the master controller.

9. The vacuum arc remelting (VAR) system according to claim 1, wherein each of the primary electromagnetic energy source and the secondary electromagnetic energy source comprises a coil assembly having a magnetic core and a plurality of coil pairs wrapped around the magnetic core, wherein the coil assembly is operable to generate a magnetic field from the coil assembly based on electric current flowing in the plurality of coil pairs.

10. The vacuum arc remelting (VAR) system according to claim 9, wherein each of the coil assemblies includes three coil pairs.

11. The vacuum arc remelting (VAR) system according to claim 10, wherein a coil pair of the three coil pairs comprises a first layer winding and a second layer winding, the first winding configured to receive first electric current from a first circuit of a controller and the second winding configured to receive second electric current from a second circuit of the controller.

12. The vacuum arc remelting (VAR) system according to claim 9, wherein each of the magnetic cores form a respective toroid, and wherein a center of each respective toroid is coaxial with the longitudinal axis.

13. The vacuum arc remelting (VAR) system according to claim 1, wherein the primary electromagnetic energy source moves along the longitudinal axis of the crucible assembly.

14. The vacuum arc remelting (VAR) system according to claim 13, further comprising upper and lower limit switches configured to limit travel of the primary electromagnetic energy source.

15. The vacuum arc remelting (VAR) system according to claim 1, further comprising a position sensor configured to limit travel of the primary electromagnetic energy source.

16. A vacuum arc remelting (VAR) system for forming an ingot from an electrode, the system comprising:
a crucible assembly configured to accommodate the electrode and the ingot, wherein the crucible assembly includes an upper end portion and a lower end portion;
a primary electromagnetic energy source arranged about the crucible assembly, wherein the primary electromagnetic energy source and the crucible assembly are configured to move relative to one another along a longitudinal axis of the crucible assembly;
a secondary electromagnetic energy source arranged about the upper end portion of the crucible assembly, wherein the secondary electromagnetic energy source is stationary and fixed to the upper end portion of the crucible assembly; and
a current controller configured to provide electric current to the primary electromagnetic energy source.

17. The vacuum arc remelting (VAR) system according to claim 16, wherein the current controller increases the electric current being provided to the primary electromagnetic energy source as the primary electromagnetic energy source reaches a predetermined height.

18. The vacuum arc remelting (VAR) system according to claim 17, wherein the electric current being provided to the primary electromagnetic energy source is increased exponentially to a saturation level associated with the predetermined height.

19. The vacuum arc remelting (VAR) system according to claim 18, further comprising a master controller is configured to provide commands to the current controller to increase the electric current being provided to the secondary electromagnetic energy source after the electric current being provided to the primary electromagnetic energy source reaches the saturation level.

20. A vacuum arc remelting (VAR) system for forming an ingot from an electrode, the system comprising:
a crucible assembly configured to accommodate the electrode and the ingot, wherein the crucible assembly includes an upper end portion and a lower end portion;
a primary electromagnetic energy source arranged about the crucible assembly, wherein the primary electromagnetic energy source and the crucible assembly are configured to move relative to one another along a longitudinal axis of the crucible assembly;
a secondary electromagnetic energy source arranged about the upper end portion of the crucible assembly, wherein the secondary electromagnetic energy source is stationary and fixed to the upper end portion of the crucible assembly;
a primary current controller configured to provide electric current to the primary electromagnetic energy source;
a secondary current controller configured to provide electric current to the secondary electromagnetic energy source; and
a master controller configured to receive process inputs from the primary current controller and the secondary current controller and to provide current settings to each of the primary current controller and the secondary current controller based on the process inputs, the master controller further configured to communicate with a main VAR furnace controller,
wherein the process inputs comprise position of the primary electromagnetic energy source and electric current being provided to each of the primary electromagnetic energy source and the secondary electromagnetic energy source, and
wherein magnetic fields generated by the primary electromagnetic energy source and the secondary electromagnetic energy source are localized to an arc region during remelting.

21. A vacuum arc remelting (VAR) system for forming an ingot from an electrode, the system comprising:
a crucible assembly configured to accommodate the electrode and the ingot, wherein the crucible assembly includes an upper end portion and a lower end portion;
an axial electromagnetic energy source wound about the longitudinal axis of the crucible assembly;
a primary electromagnetic energy source arranged about the crucible assembly, wherein the primary electromagnetic energy source and the crucible assembly are configured to move relative to one another along a longitudinal axis of the crucible assembly; and
a secondary electromagnetic energy source arranged about the upper end portion of the crucible assembly, wherein the secondary electromagnetic energy source is stationary and fixed to the upper end portion of the crucible assembly.

22. The system of claim 21, further comprising:
a current controller configured to provide electric current to the primary electromagnetic energy source, wherein the current controller is further configured to:
maintain current provided to the primary electromagnetic energy source; and
increase the current provided to the primary electromagnetic energy source, wherein the current provided to the primary electromagnetic energy source is increased according to an approximated height of the ingot.

23. The system of claim 21, further comprising:
a controller comprising a processor and a non-transitory computer-readable medium, the non-transitory computer-readable medium comprising instructions executable by the processor to provide electric current to the primary electromagnetic energy source, wherein the instructions:
maintain current provided to the primary electromagnetic energy source; and
increase the current provided to the primary electromagnetic energy source, wherein the current provided to the primary electromagnetic energy source is increased according to an approximated height of the ingot.
